(19) United States
(12) Patent Application Publication
(10) Pub. No.: US 2005/0265435 A1
(43) Pub. Date: Dec. 1, 2005

(54) Selectively configurable bidirectional switching interface

(75) Inventor: Bonnie Jean Flory, Toney, AL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ADTRAN, INC., HUNTSVILLE, AL (US)

(21) Appl. No.: 10/858,419

(22) Filed: Jun. 1, 2004

(51) Int. Cl. H04B 1/38

(52) U.S. Cl. 375/220

(57) ABSTRACT

An arrangement for interfacing signals between a control processor of a digital communication equipment shelf and diverse types of telecommunication equipment includes a multipin communication port that is configured to be coupled by way of a communication cable to either data communication equipment or data terminal equipment. A relay switch is coupled to the multipin communication port and is operative, under processor control, to selectively terminate internal leads of the multipin communication port to first and second sets of communication source/terminations, respectively associated with data communication equipment and data terminal equipment.

### FIELD OF THE INVENTION

The present invention relates in general to communication systems and subsystems therefor, and is particularly directed to a bidirectional switching interface that allows a prescribed multiport connector, such as an RS-232 connector, to be selectively configured, under software control, so that it may interface signals between a control processor of a digital communication equipment shelf and diverse types of telecommunication equipment such as data communication equipment and data terminal equipment.

### BACKGROUND OF THE INVENTION

Digital telecommunication equipment banks are designed to be utilized by and interface with a variety of telecommunication devices. As a non-limiting example, a digital communication equipment shelf may be designed to interface locally with a data communication equipment (DCE) workstation, or remotely via a modem and the public switched telephone network (PSTN) with data terminal equipment (DTE). The interface on the equipment backplane that is often used for this purpose is a prescribed multiterminal connector, such as a multipin RS-232 connector.

To accommodate the signaling interfaces necessary to serve multiple types of devices, it has been common practice to provide a set of jumpers between the internal side of the RS-232 connector and leads on an associated backplane card, that are coupled to internal circuitry dedicated to handling either DCE- or DTE-based signaling. As such it is necessary for a user to physically remove a backplane card and insert or remove jumper connectors with respect to their associated terminals, whenever a change in the type of equipment being interfaced is required.

### SUMMARY OF THE INVENTION

In accordance with the present invention, this shortcoming is effectively obviated by terminating the internal side of the RS-232 connector with a set of relay switches, the settings for which are controlled via a software option, so that the connector will appear to the end user as either being connected for DCE usage or DTE usage. Namely, where the connector is to be used to route signals locally with respect to a piece of DCE equipment, the relay switches are set to route the appropriate pins of the RS-232 switch to internal circuitry on the controller card associated with DCE equipment protocol. Conversely, where the connector is to be used to route signals remotely with respect to DTE equipment, the relay switches are set to route the appropriate pins of the RS-232 switch to internal circuitry on the controller card associated with DTE equipment protocol. This means that a common cable can be used with the RS-232 connector, as terminal settings are performed internally of the equipment shelf controller card on which the RS-232 connector is mounted.

### BRIEF DESCRIPTION OF THE DRAWINGS

FIG. 1 is a diagrammatic pictorial view of the external side of a backplane controller card having its RS-232 connector internally coupled to a DCE/DTE relay switch and externally coupled with a cable serving data communication equipment; and

FIG. 2 is a diagrammatic pictorial view of the external side of a backplane controller card having its RS-232 connector internally coupled to a DCE/DTE relay switch, and externally coupled with a cable serving data terminal equipment.

### DETAILED DESCRIPTION

Before describing the bidirectional switching interface of the present invention, it should be observed that the invention resides primarily in a modular arrangement of conventional communication electronic circuits and electronic signal processing circuits and components therefor. In a practical implementation that facilitates packaging in a hardware-efficient equipment configuration, these modular arrangements may be readily implemented as field programmable gate array (FPGA)-, or application specific integrated circuit (ASIC)-based chip sets. Consequently, the configuration of such an arrangement of circuits and components and the manner in which they are interfaced with one another have, for the most part, been illustrated in the drawings in readily understandable block diagram format, which show only those specific details that are pertinent to the present invention, so as not to obscure the disclosure with details which will be readily apparent to those skilled in the art having the benefit of the description herein. The block diagram illustrations are primarily intended to show the components of the invention in a convenient functional grouping, whereby the present invention may be more readily understood.

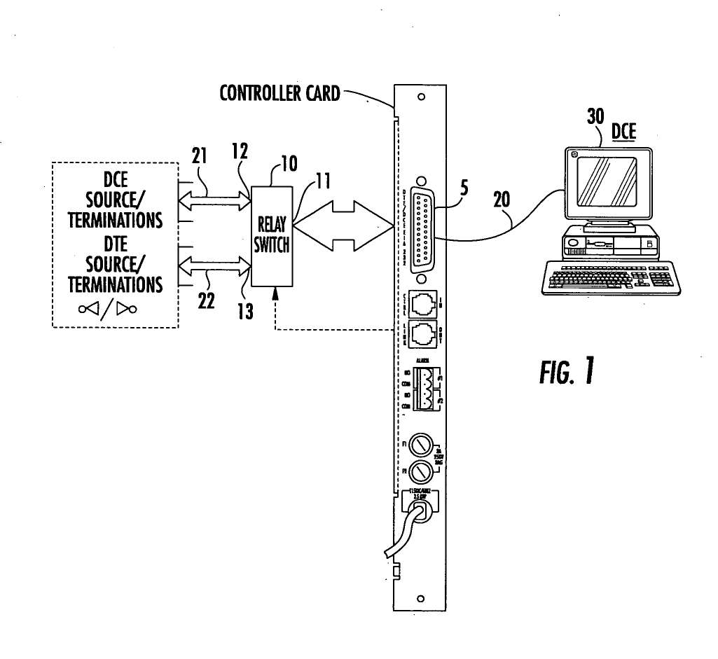

Attention is initially directed to FIG. 1, which is a diagrammatic pictorial view of the external side of a backplane controller card having its RS-232 connector 5 internally coupled to a first set of leads 11 of a DCE/DTE relay switch 10 and externally coupled with a cable 20 serving data communication equipment 30. The DCE/DTE relay switch 10 provides routing of internal connections to one of two circuit paths. The first path 21, extending from a second set of leads 12 of the relay switch, establishes input/output leads to and from the controller card's source/terminations for the option that the external equipment is DCE equipment, which is the case shown. The second path 22, extending from a third set of leads 13 of the relay switch, establishes input/output leads to and from the controller card's source/terminations for the option that the external equipment is DTE equipment. Since FIG. 1 is associated with the connection to data communication equipment, the relay switch option is to the first (DCE) path 21.

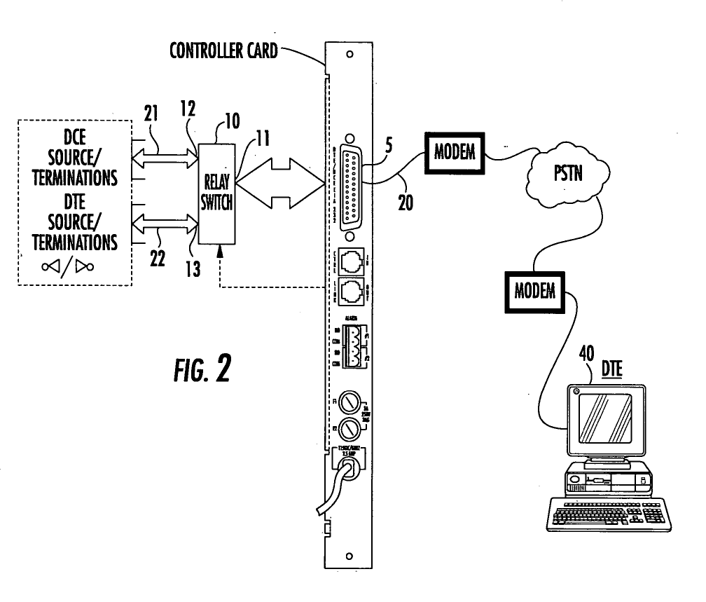

FIG. 2 is a diagrammatic pictorial view of the external side of a backplane controller card having its RS-232 connector internally coupled to a DCE/DTE relay switch 10 and externally coupled with cable 20 serving data terminal equipment 40. Because the cable 20 is connected to a modem path for data terminal equipment, the second (DTE) path 22, associated with the third set of leads 13, through the relay switch 10 is selected. As a result, input/output ports of the controller card's source/terminations are coupled via leads of the RS-232 connector that are associated with input/output voltage levels for DTE protocol-based signaling.

While I have shown and described an embodiment in accordance with the present invention, it is to be understood that the same is not limited thereto but is susceptible to numerous changes and modifications as known to a person skilled in the art. I therefore do not wish to be limited to the details shown and described herein, but intend to cover all such changes and modifications as are obvious to one of ordinary skill in the art.

1. An arrangement for interfacing signals between a control processor of a digital communication equipment shelf and diverse types of telecommunication equipment comprising:
a multipin communication port configured to be coupled by way of a communication cable to multiple types of telecommunication equipment;
a relay switch coupled to said multipin communication port and being operative, under processor control, to selectively terminate internal leads of said multipin communication port to first and second sets of communication source/terminations, respectively associated with first and second types of telecommunication equipment.

2. The arrangement according to claim 1, wherein said first type of telecommunication equipment corresponds to data communication equipment, and said second type of telecommunication equipment corresponds to data terminal equipment.

3. A method of interfacing signals between a control processor of a digital communication equipment shelf and diverse types of telecommunication equipment comprising the steps of:
(a) providing a multipin communication port that is configured to be coupled by way of a communication cable to multiple types of telecommunication equipment;
(b) coupling respective pins of said multipin communication port to a first set of terminals of a relay switch, said relay-switch having a second set of terminals that are coupled with communication source/terminations associated with a first type of telecommunication equipment, and a third set of terminals that are coupled with communication source/terminations associated with a second type of telecommunication equipment; and
(c) selectively operating said relay switch so as to couple pins of said multipin communication port to one of said second and third sets of terminals in association with a selected one of said first and second types of telecommunication equipment, with which said control processor of said digital communication equipment shelf is to be interfaced.

4. The method according to claim 3, wherein said first type of telecommunication equipment corresponds to data communication equipment, and said second type of telecommunication equipment corresponds to data terminal equipment.
